(19) United States
(12) Patent Application Publication
(10) Pub. No.: US 2026/0318235 A1
(43) Pub. Date: Oct. 15, 2026

(54) BLOWER SYSTEM FOR CARBON CAPTURE

(71) Applicant: Echeneidae Inc., Wixom, MI (US)

(72) Inventor: Upendra Patel, Canton, MI (US)

(21) Appl. No.: 19/174,577

(22) Filed: Apr. 9, 2025

(51) Int. Cl. F01N 3/02; B01D 53/04; B61C 5/04; F01N 3/05

(52) U.S. Cl. CPC F01N 3/0205; B01D 53/0438; B01D 53/0446; B61C 5/04; F01N 3/05; B01D 2257/504; B01D 2259/4566

(57) ABSTRACT

Embodiments include an exhaust treatment system including a first heat exchanger configured to cool exhaust gas being transmitted from an aftertreatment system, a second heat exchanger configured to cool at least a first portion of exhaust gas being transmitted from the first heat exchanger, a first blower, a second blower configured to transmit the exhaust gas to a carbon capture system, and a controller configured to control operation of the first blower and the second blower. Some embodiments include a railcar system including an exhaust treatment system that includes an aftertreatment system, a first heat exchanger, a second heat exchanger, a first blower, a second blower, a controller, and a carbon capture system. Some embodiments include a method of transmitting locomotive engine exhaust gas. The method can include providing an exhaust treatment system and controlling a flow of exhaust gas from the locomotive through the exhaust treatment system.

### FIELD

This disclosure generally relates to locomotive engines. More particularly, the present disclosure relates to a blower system for transmitting locomotive engine exhaust gas to and through a carbon capture system.

### BACKGROUND

Locomotive engine exhaust includes various chemical species, which may be regulated by government agencies. For example, locomotive engine exhaust can include hydrocarbons (HC), oxides of nitrogen (NOx), particulate matter (PM), carbon monoxide (CO), and carbon dioxide (CO₂). Governmental regulations can vary, but in many jurisdictions, the locomotive engine exhaust may be emitted into the atmosphere without treatment. For example, uncontrolled locomotive engine emissions may satisfy the Environmental Protection Agency (EPA) Tier 0+ emissions standards. There are beneficial effects of removing some or all such harmful chemicals from locomotive engine exhaust before emission into the atmosphere (e.g., meeting stricter governmental regulations in specific jurisdictions, decreasing air pollution generally, facilitating capture of carbon dioxide, etc.).

### SUMMARY

In general, this disclosure is directed to locomotive engines and, more particularly, to a blower system for transmitting locomotive engine exhaust gas to a carbon capture system. In one example, the present disclosure includes an exhaust treatment system. The exhaust treatment system can include a first heat exchanger configured to cool exhaust gas transmitted from an aftertreatment system. The exhaust treatment system can also include a second heat exchanger configured to cool at least a first portion of exhaust gas transmitted from the first heat exchanger. The exhaust treatment system can also include a first blower. The exhaust treatment system can also include a second blower, where the second blower is configured to transmit the exhaust gas to a carbon capture system. The exhaust treatment system can also include a controller configured to control operation of the first blower and the second blower.

In another example, the present disclosure includes a railcar system. The railcar system can include an exhaust treatment system. The exhaust treatment system can include an aftertreatment system. The exhaust treatment system can also include a first heat exchanger. The exhaust treatment system can also include a second heat exchanger. The exhaust treatment system can also include a first blower. The exhaust treatment system can also include a second blower. The exhaust treatment system can also include a controller configured to control operation of the first blower and the second blower. The exhaust treatment system can also include a carbon capture system configured to remove carbon dioxide from exhaust gas, where the second blower is configured to transmit the exhaust gas to the carbon capture system.

In another example, the present disclosure includes a method of transmitting locomotive engine exhaust gas. The method can include providing an exhaust treatment system. The exhaust treatment system can include an aftertreatment system. The exhaust treatment system can also include a first heat exchanger configured to cool exhaust gas being transmitted from the aftertreatment system. The exhaust treatment system can also include a second heat exchanger configured to cool at least a first portion of exhaust gas being transmitted from the first heat exchanger. The exhaust treatment system can also include a first blower. The exhaust treatment system can also include a second blower. The exhaust treatment system can also include a carbon capture system configured to remove carbon dioxide from the exhaust gas from a locomotive, where the second blower is configured to transmit the exhaust gas to the carbon capture system. The method can also include controlling a flow of exhaust gas from the locomotive through the exhaust treatment system.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a block diagram of a railcar system, according to an embodiment.

FIG. 2 is a schematic diagram of the locomotive and the capture car, according to an embodiment.

FIGS. 3A and 3B are block diagrams of railcar systems with an exhaust treatment system, according to an embodiment.

FIG. 4 is a block diagram of an example exhaust treatment system with serial blowers, according to an embodiment.

FIG. 5 is a block diagram of an example exhaust treatment system with serial blowers, according to an embodiment.

FIG. 6 is a block diagram of an example exhaust treatment system with parallel blowers, according to an embodiment.

FIG. 7 is a block diagram of an example exhaust treatment system with parallel blowers, according to an embodiment.

FIG. 8 is a block diagram of an example exhaust treatment system with parallel blowers, according to an embodiment.

FIG. 9 is a block diagram of an example exhaust treatment system with a combination of parallel and series components, according to an embodiment.

FIG. 10 is a flowchart of a method for transmitting exhaust through an exhaust treatment system, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

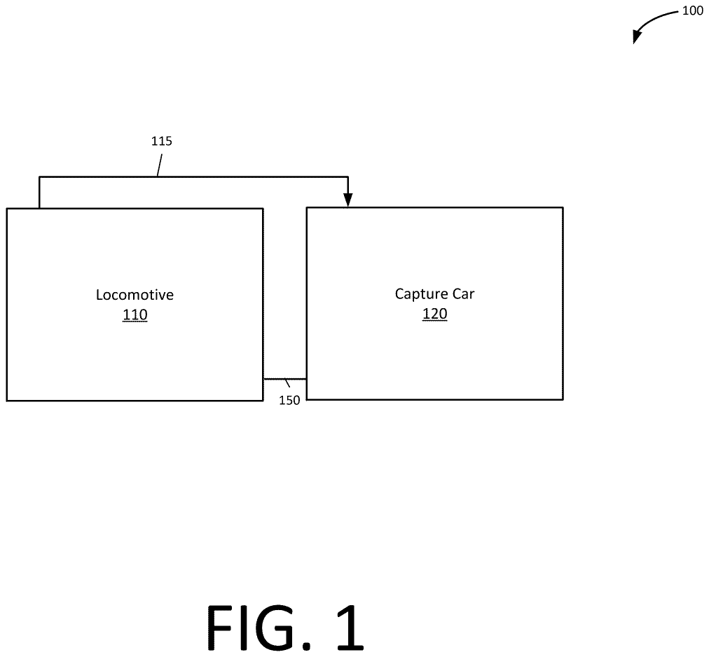

FIG. 1 illustrates a block diagram of a railcar system 100, according to an embodiment. The railcar system 100 can include a locomotive car 110 (also referred to herein as simply a locomotive 110). In some embodiments, although a single locomotive 110 is depicted, a railcar system 100 can include any number of locomotives 110. A typical locomotive can release all of its engine exhaust into the atmosphere.

In some embodiments, to realize the various beneficial effects of removing some or all such harmful chemicals from locomotive 110 engine exhaust (i.e., the engine exhaust of locomotive 110) before emission into the atmosphere (e.g., meeting stricter governmental regulations in specific jurisdictions, decreasing air pollution generally, facilitating capture of carbon dioxide, etc.), an aftertreatment system (ATS) can be used to treat locomotive 110 engine exhaust. In particular, the ATS can remove some or all of the HC, NOx, PM, and CO from locomotive 110 engine exhaust. The ATS may be located on a capture car 120 that is separate from the locomotive 110. In some embodiments, although a single capture car 120 is depicted, the railcar system 100 can include any number of capture cars (for example, two capture cars) for a locomotive 110. The capture car 120 can be connected mechanically (through mechanical coupling 150) to the locomotive 110 to ensure that the capture car 120 moves along with the locomotive 110. An exhaust duct assembly 115 can transmit the locomotive 110 engine exhaust from the locomotive 110 to the capture car 120 (also known as a ‘tender car’). In many examples, the capture car 120 can house a carbon capture system (CCS) that removes carbon dioxide from the locomotive 110 engine exhaust. However, in order for the carbon capture system to effectively remove carbon dioxide from the locomotive engine exhaust, the ATS may first need to remove some or all of the HC, NOx, PM, and CO. Removal of such chemicals can reduce air pollutants associated with the exhaust while also mitigating the risk of fouling, plugging, or other unwanted interactions and/or effects on the CCS associated with the chemicals.

As noted, locomotives produce exhaust gas, which can be treated to reduce the quantity of various gases and/or particulate matter associated with the exhaust gas. The conditioning and treatment of the exhaust gas can be completed to improve emissions of the locomotive (e.g., to comply with governmental regulations). In addition, the exhaust gas can be processed to reduce emission of CO₂. However, carbon capture systems can require the filtering and/or removal of gases and/or particulate matter such as HC, NOx, PM, and CO prior to the processing of the CO₂, which can improve CO₂ capture. Therefore, in some instances, an ATS can be used to remove some or all of the HC, NOx, PM, and CO from locomotive 110 engine exhaust.

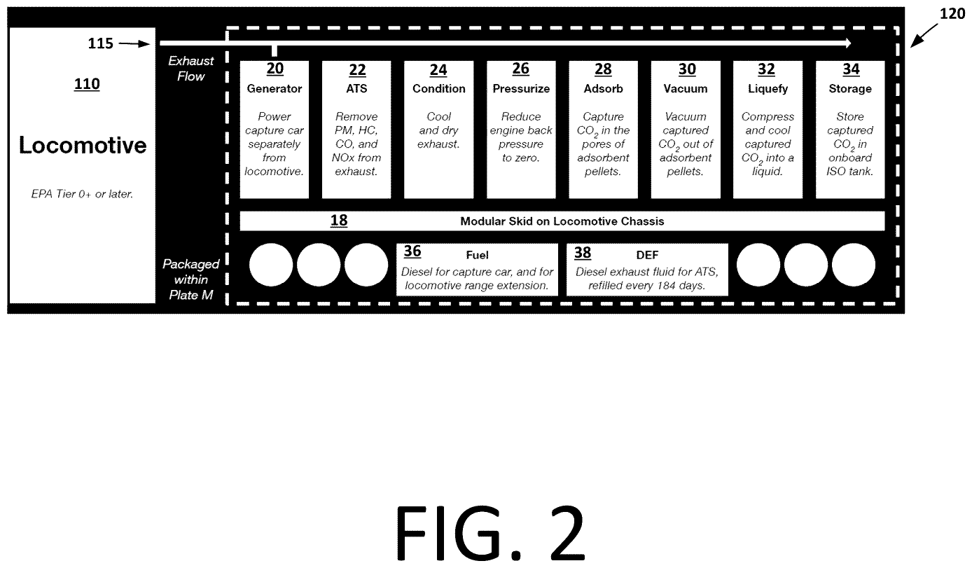

FIG. 2 illustrates a railcar system 200, including a locomotive 110 and a capture car 120, that is configured to process locomotive exhaust. In some embodiments, railcar system 200 can be the same and/or similar as railcar system 100. In some embodiments, to process exhaust from the locomotive 110, a car (e.g., a train car), referred to herein as a capture car 120, can be connected/coupled to the locomotive 110 (and can move along with the locomotive 110). The capture car 120 can receive exhaust from the locomotive 110 (for example, through an exhaust duct assembly 115) and can process the exhaust.

In some applications, the locomotive 110 can be a diesel-powered system. The locomotive 110 and capture car 120 can be in fluidic communication with one another. An exhaust duct assembly 115 can direct the flow of exhaust from the locomotive 110 to the capture car 120, in some embodiments. The locomotive exhaust can have a variety of characteristics. In some applications, the unprocessed locomotive exhaust can achieve Tier 0+ EPA locomotive emissions standards. Tier 0+ emission standards can include particulate matter requirements such as 8.0 g/bhp-hr NOx, 0.22 g/bhp-hr PM, 1.0 g/bhp-hr HC, and 5.0 g/bhp-hr CO. However, as noted, it can be desirable to further reduce the emissions of locomotives by treating and/or processing the locomotive exhaust.

The capture car 120 can include various components and/or modules for treatment of the locomotive exhaust. Each of the components for exhaust treatment can be a part of a modular skid (not pictured). The modular skid can be mounted to a locomotive chassis 18. The modular skid can include, for example, a generator 20, an aftertreatment system (ATS) 22, a conditioning module 24, a pressurization module 26, an adsorption module 28, a vacuum module 30, a liquification module 32, and a storage module 34. The capture car 120 can also include fuel storage tanks 36 and diesel exhaust fluid 38, or DEF, for the ATS 22. The DEF can be an aqueous urea solution.

The auxiliary power generator 20 of the capture car 120 can be configured to power the various capture car modules. In some examples, the generator 20, also referred to herein as a “genset,” can have multiple generator units. The capture car 120 requires electrical power to operate the exhaust processing equipment thereon. As the capture car 120 does not rely on the locomotive engine to provide power, one or more electrical generator units are included in the capture car 120. In some instances, the genset 20 can have three generator units. The generator unit(s) can be diesel generators. These generator units can be configured to meet emissions levels in compliance with any relevant regulatory requirements, such as Tier 3 or Tier 4 emissions standards.

In some embodiments, the modular skid can include additional components for the processing of locomotive exhaust. For example, the exhaust can be conditioned via a conditioning module 24. The conditioning process can include cooling and drying the exhaust. The system can include a pressurization module 26 configured to control the engine back pressure. CO₂ can be captured in adsorbent pellets via adsorption module 28. The pellets can have pores configured to capture the CO₂. A vacuum module 30 can be used to extract the CO₂ from the adsorbent pellets. The CO₂ can be compressed and cooled such that the CO₂ liquifies as it is captured via a liquification module 32. Once liquified, the CO₂ can be stored in a storage module 34 on the capture car 120. In some embodiments, the conditioning module 24, pressurization module 26, adsorption module 28, vacuum module 30, liquification module 32, and storage module 34 may be considered part of the CCS. For instance, as discussed herein, the exhaust may go through the ATS 22 to remove PM, HC, CO, and NOx from the exhaust, and then the remaining exhaust may then go through the CCS (including modules 24, 26, 28, 30, 32, 34, etc.) to remove carbon dioxide from the exhaust.

While the capture car 120 and its corresponding ATS 22 and/or CCS (e.g., including modules 24, 26, 28, 30, 32, 34, etc.) can be extremely beneficial by effectively removing carbon dioxide (as well as some or all of the HC, NOx, PM, and CO) from locomotive engine exhaust (thus reducing air pollutants associated with the exhaust while also mitigating various risks and unwanted effects on the CCS associated with the various chemicals), it may be difficult to transport the exhaust from the locomotive car 110 to the capture car 120.

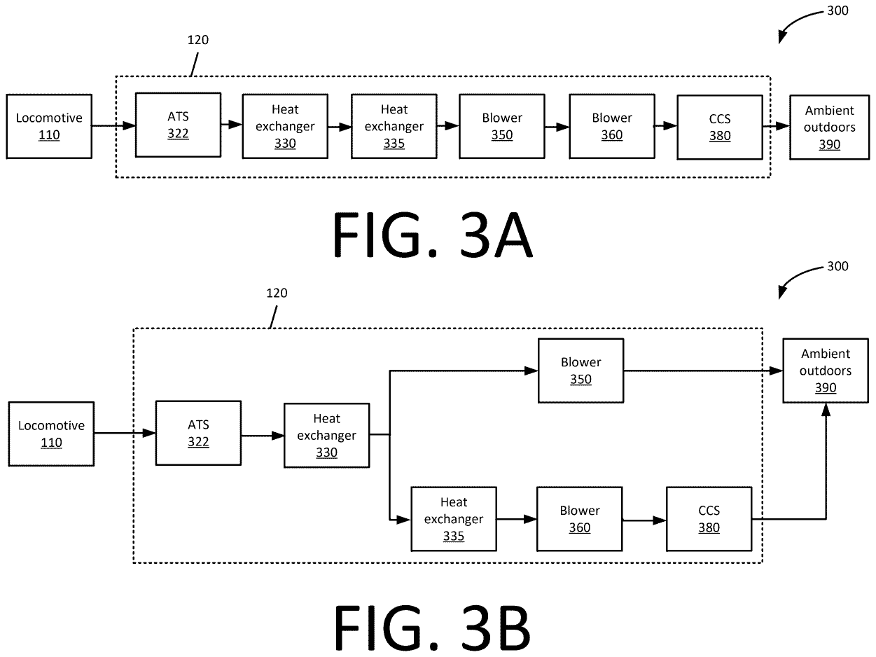

FIGS. 3A and 3B illustrate block diagrams of a railcar system with an exhaust treatment system 300, according to an embodiment. Although the exhaust treatment systems (300, 400, 500, 600, 700, 800, and 900) are discussed herein in relation to a railcar system, these exhaust systems could also be included in non-railcar applications such as ships and/or various other machinery. FIG. 3A illustrates an exhaust treatment system 300 with serial blowers (350 and 360). FIG. 3B illustrates the exhaust treatment system 300 with parallel blowers (350 and 360). As discussed herein, exhaust from a locomotive 110 can be transmitted to a capture car 120, where the exhaust can be treated (for example, by an aftertreatment system (ATS) 322 and a carbon capture system (CCS) 380) to remove various harmful chemicals from the exhaust before it is released into the atmosphere (i.e., ambient outdoors 390). In some embodiments, the ATS 322 can remove chemicals such as HC, NOx, PM, and CO from the locomotive exhaust and the CCS 380 can remove carbon dioxide (CO₂) from the locomotive exhaust. By removing these chemicals from the exhaust, the remaining exhaust that is released into the ambient outdoors 390 can be much less harmful for the environment and can have improved environmental qualities such as, for example, meeting stricter governmental regulations in specific jurisdictions, decreasing air pollution generally, facilitating capture of carbon dioxide, etc.

However, in some embodiments, there can be various challenges in transmitting the exhaust through the various exhaust treatment components on the capture car 120. For instance, the CCS 380 may be more effective and/or efficient with targeted pressure, temperature, and humidity ranges for the exhaust gas, and may not be effective at removing the carbon dioxide without these various ranges. Further, the CCS 380 may be more effective and/or efficient with certain flow rates of exhaust gas, and can surge or choke if the flow rate is too low or too high, respectively. Therefore, it is desirable for the exhaust treatment system 300 to variably pull process gas (i.e., locomotive 110 exhaust) from the locomotive 110 engine outlets and through system (e.g., system 300) components while maintaining atmospheric pressure at the outlets for variable flow rates. It is also important for the exhaust treatment system 300 to minimize and/or eliminate backpressure to engine outlets to avoid adverse impact on emissions, total shaft power output, long term engine related durability, controllability, etc. Thus, the exhaust treatment system 300 can include a plurality of blowers 350 and 360 between the ATS 322 and CCS 380 in order to variably push the exhaust gas into target gas flow rates at variable target pressures into the CCS 380 (for example, from the ATS 322). In some embodiments, while it is discussed and depicted herein that the exhaust gas is being transmitted from the ATS 322 to the CCS 380, the exhaust gas could be transmitted to the CCS 380 from any component.

As discussed herein, FIG. 3A depicts the exhaust treatment system 300 with serial blowers 350 and 360. Having the blowers 350, 360 in series can achieve the various targeted pressure, temperature, and humidity ranges of the exhaust gas while avoiding sub-freezing cooling and avoiding complex, large, heave, and/or inefficient sub-freezing refrigeration system(s). For instance, serial blowers 350, 360 facilitate condensation between blowers by making natural use of compression already required for the carbon capture process to increase the dew point of the process gas (i.e., exhaust gas).

In some embodiments, an exhaust treatment system 300 with serial blowers 350 and 360 can include a locomotive 110, an aftertreatment system (ATS) 322, a first heat exchanger 330, a second heat exchanger 335, a first blower 350, a second blower 360, and a carbon capture system (CCS) 380. In some embodiments, as depicted in FIGS. 3A and 3B, the heat exchangers 330, 335 can be charge air cooler(s) (CAC(s)) and/or water charge air cooler(s) (WCAC(s)). In some embodiments, the ATS 322, heat exchanger 330, heat exchanger 335, blower 350, blower 360, and CCS 380 may all be on/a part of the capture car 120. As discussed herein, exhaust from the locomotive 110 can be transmitted to and treated/processed by the capture car 120.

In the exhaust treatment system 300 depicted in FIG. 3A, exhaust gas can be transmitted from the locomotive 110 to the ATS 322, where some or all of chemicals such as HC, NOx, PM, and CO can be removed from the exhaust gas. This can help improve the effectiveness of the CCS 380 at removing carbon dioxide from the exhaust gas. After being transmitted through and processed by the ATS 322, the exhaust gas can be transmitted to a first heat exchanger 330 such as a charge air cooler. In some instances, the exhaust gas may be transmitted through one or more other components (not depicted) prior to the heat exchanger 330. The heat exchanger 330 can cool the exhaust gas to a more manageable temperature for the remaining components of the exhaust treatment system 300. For example, if the exhaust gas is too hot, the CCS 380 may not be able to effectively remove/separate the carbon dioxide from the exhaust gas.

Once the exhaust gas has been transmitted through the heat exchanger 330, the exhaust gas may be transmitted to a second heat exchanger 335. Heat exchanger 335 may be a charge air cooler (such as a water charge air cooler) that is used to condition the exhaust gas for target humidity and temperature for the carbon capture process (by CCS 380). This can help prepare the gas for carbon capture and can help improve the effectiveness of the CCS 380. The exhaust gas can then be transmitted from heat exchanger 335 to blower 350 and then to blower 360. As, in FIG. 3A, the blowers 350, 360 are serial blowers (i.e., in series with each other), the exhaust gas may first be transmitted to blower 350 and then from blower 350 to blower 360. Utilizing a single blower (for example, only blower 350) may not have been able to achieve the desired carbon capture conditions. These desired conditions can include a desired very high-pressure ratio, which a single blower may not be able to achieve and/or which may be very difficult for a single blower to achieve (considering size, weight, efficiency, cost, etc.). Further, utilizing a single blower may have a higher risk of having unwanted liquid state water enter into the carbon capture process (i.e., be transmitted to the CCS 380).

When utilizing two blowers in series, as depicted in FIG. 3A, the first blower (blower 350) may be controlled to maintain the exhaust gas at 0 kilopascal (kPa) Gage pressure at the ATS 322 outlet (for example, subject to blower limits for maximum gas temperatures, gas pressures, rpm, etc.). The second blower (blower 360) can be controlled to not only achieve a target pressure for the CCS 380 (in conjunction with a backpressure regulator (BPR), for example), but also to provide a target pressure at the outlet of blower 350 and the inlet of blower 360. This can help better prepare the exhaust gas for the CCS 380.

In some embodiments, as depicted in FIG. 3A, the exhaust gas can be transmitted from the blower 360 to the CCS 380. For example, the blower 360 can transmit (for example, blow) the exhaust gas from the blower 360 to the CCS 380 (e.g., the inlet of the CCS 380). By utilizing a plurality of blowers 350, 360, the exhaust gas can have the desired temperature(s), pressure(s), etc. for the CCS 380 to be effective at removing carbon dioxide from the exhaust gas. In some embodiments, once the carbon dioxide is removed (and, for example, stored) from the exhaust gas, the now cleaner exhaust gas can be released to the environment (i.e., ambient outdoors 390).

As discussed herein, an exhaust treatment system 300 can have a plurality of blowers 350, 360 that can be in series and/or in parallel. FIG. 3B depicts a first blower 350 and a second blower 360 in parallel. When utilizing parallel blowers, the exhaust gas from the locomotive 110 can go through either blower 350 or blower 360. Specifically, as depicted in FIG. 3B, once the exhaust gas has been cooled by heat exchanger 330, the exhaust gas can either be transmitted to blower 350 or to heat exchanger 335 (for example, utilizing one or more valves, as discussed further herein). The exhaust gas being transmitted to blower 350 may bypass the CCS 380 and go directly to the ambient outdoors 390. This can help re-route the fraction of exhaust gas which may not be ideal to flow into the CCS 380 (for example, exhaust gas which could cause a choke due to too high of a flow rate of gas being inputted into the CCS 380) and thus improve the functioning and effectiveness of the CCS 380. As exhaust gas being transmitted to the blower 350 may be transmitted to the ambient outdoors 390, the exhaust gas may only need to be cooled enough to go through the blower 350 but may not need to be tailored for the CCS 380. Therefore, exhaust gas that is being transmitted and/or bypassed to the blower 350 may be transmitted only through the heat exchanger 330.

In some embodiments, exhaust gas that is being transmitted through the blower 360 and to the CCS 380 may be transmitted through the heat exchanger 335 (after being transmitted through the heat exchanger 330) in order to condition the exhaust gas for target humidity and temperature for the carbon capture process (by CCS 380). Similar to FIG. 3A, once the exhaust gas has been treated by the CCS 380 and the carbon dioxide has been removed, the now cleaner exhaust gas can be released to the environment (i.e., ambient outdoors 390).

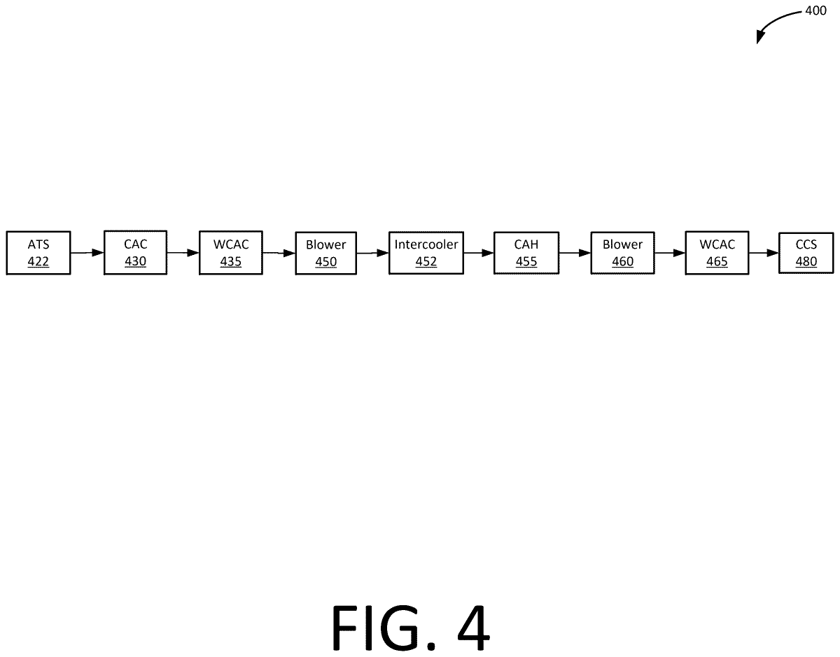

In some embodiments, while FIGS. 3A and 3B may depict exhaust treatment systems 300 with certain components, these exhaust treatment systems can include additional and/or different components. For instance, FIG. 4 illustrates an exhaust treatment system 400 (for example, the same as and/or similar to exhaust treatment system 300 in FIG. 3A) with additional components. Some components, such as ATS 422, CAC 430, blower 450, blower 460, CCS 480, etc. may be the same as and/or similar to ATS 322, heat exchanger 330, blower 350, blower 360, CCS 380, etc., respectively from FIG. 3A.

In some embodiments, upstream and/or downstream can be used to describe various components of the exhaust treatment system 300 and their positioning (for example, in relation to each other). Upstream can refer to components that are in the opposite direction from the exhaust gas flow and downstream can refer to components that are in the direction of the exhaust gas flow. For example, ATS 322 can be downstream from locomotive 110, heat exchanger 330 can be downstream from ATS 322, etc. As another example, heat exchanger 335 can be upstream from blower 360, blower 360 can be upstream from the CCS 380, etc.

In some embodiments, the exhaust treatment system 300 can include various additional components. For example, the exhaust treatment system 300 could include an additional heat exchanger between the blower 360 and the CCS 380 (i.e., upstream from the CCS 380 and downstream from the blower 360). Exhaust gas can undergo changes (such as an increase in temperature) when being transmitted through the blower 360, therefore an additional heat exchanger could be utilized to ensure a target temperature, pressure, and/or humidity of the exhaust gas prior to entering the CCS 380. In some embodiments, for example when the blowers 350, 360 are in series (as depicted in FIG. 3A), the exhaust treatment system 300 can include a heat exchanger between the blower 350 and the blower 360. This heat exchanger could be the same as or similar to the intercooler 452 discussed further herein.

Similar to exhaust treatment system 300 with serial blowers (depicted in FIG. 3A), exhaust treatment system 400 may include an ATS 422 that treats exhaust gas from a locomotive prior to the exhaust gas being transmitted to the CCS 480. The exhaust gas can be transmitted from ATS 422 to CAC 430 in order to help cool the temperature of the exhaust gas. In some embodiments, CAC 430 is an ambient air charge air cooler (CAC). For example, CAC 430 can be a gas-gas heat exchanger with cooling fans to cool exhaust gas with lower temperature ambient air. In some instances, internal condensing can also occur at CAC 430 (discussed further herein).

As discussed herein, the process gas (i.e., the exhaust gas) can go through multiple heat exchangers/coolers in order to effectively cool and condition the exhaust gas. For instance, the first CAC (i.e., CAC 430) can use ambient air to cool the exhaust gas to a more manageable temperature for the other components of the system 400. However, as discussed herein, the CCS 480 may need and/or desire certain temperature, pressure, etc. in order to effectively separate the carbon dioxide from the exhaust gas. Therefore, a second CAC can be used to condition the exhaust gas for target humidity and temperature for the carbon capture process (by CCS 480). As discussed in relation to FIG. 3A, the second CAC can be a charge air cooler. In some embodiments, the second CAC can be a water charge air cooler such as WCAC 435. For example, WCAC 435 can be a gas-coolant heat exchanger with cooling water from a chiller. The exhaust gas can be transmitted from WCAC 435 to the first blower 450. In some embodiments, the blowers 450, 460 can be any device which provides gas flow by creating a differential pressure (such as blowers, compressors, and/or fans). For example, in some instances, blowers 450 and/or 460 can be superchargers driven variably by motors.

In some embodiments, as depicted in FIG. 4, there can be an intercooler (such as intercooler 452) between the serial blowers 450, 460 (for example, blowers 450 and 460 can be separated by at least intercooler 452). Even though the WCAC 435 can be used to condition the exhaust gas to a target humidity and temperature for the CCS 480, each blower 450, 460 can still affect the exhaust gas and its properties/conditions. For instance, the blower(s) 450, 460 can cause a temperature change (e.g., increase in temperature), a humidity change, a pressure change, etc. Therefore, having intercooler 452 positioned between the blowers 450, 460 can further condition the exhaust gas (e.g., the temperature, pressure, and/or humidity of the exhaust gas) for the CCS 480. For example, the intercooler 452 can be a WCAC that is cooled to a target temperature based on an actual humidity measured, optimal design pressure at the intercooler 452, and the target humidity wanted for the carbon capture core (at the CCS 480).

In some embodiments, exhaust treatment system 400 can include a heat exchanger such as a charge air heater (CAH 455) between the intercooler 452 and the second blower 460. Thus, in such embodiments, blower 450 and blower 460 can be separated by the intercooler 452 and the CAH 455. In certain instances, the exhaust gas may need to be heated before going to the CCS 480. CAH 455 can heat the exhaust gas. For example, if the target pressure and/or target humidity for carbon capture (at the CCS 480) is low while the target temperature is high, it is possible that blower 450 and/or blower 460 may not provide enough energy into the exhaust gas due to low compression at the outlet of blower 460 (for example). The CAH 455 can be an energy efficient solution that uses ambient potential heating, for example, to raise the exhaust gas temperature. This can help condition the exhaust gas for carbon capture and the CCS 480.

In some embodiments, the exhaust treatment system 400 can include another heat exchanger (WCAC 465) between the second blower 460 and the CCS 480. WCAC 465 can be another water charge air cooler type heat exchanger, in some instances. WCAC 465 can be used to reduce the temperature of the exhaust gas (for example, to a target temperature) due to a temperature rise caused by blower 460. In some embodiments, WCAC 465 may not condense water from the exhaust gas. After going through WCAC 465, the exhaust gas may have the desired/target temperature (as well as the desired/target pressure and humidity from the WCAC 465, blowers 450 and 460, intercooler 452, CAH 455, etc.) for carbon capture and the CCS 480.

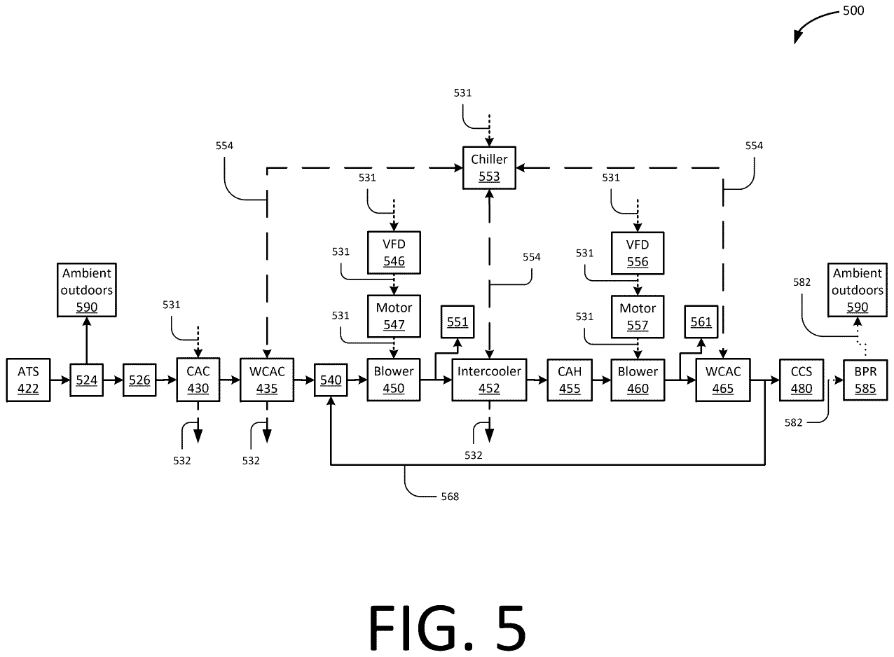

FIG. 5 illustrates a more complex exhaust treatment system 500 with serial blowers, according to an embodiment. In some embodiments, exhaust treatment system 500 can be exhaust treatment system 400 with additional components. As discussed herein, an exhaust treatment system 500 with serial blowers (e.g., blowers 450 and 460) can enable characterizing and optimizing various parameters of the exhaust gas for a more efficient (e.g., energy consumed per mass of carbon captured) and effective exhaust treatment processes. For example, the use of serial blowers 450, 460 can help achieve the various targeted pressure, temperature, and humidity ranges of the exhaust gas.

In some embodiments, the exhaust treatment system 500 includes a bypass valve 524 after the ATS 422 to allow exhaust gas to bypass the CCS 480 and instead be released into the ambient outdoors 590 (i.e., the atmosphere). The bypass valve 524 and its ability to divert/bypass the CCS 480 can help prevent some or all of the exhaust gas from flowing through the components and the CCS 480 in instances when it is not desirable to (for example, when the CCS 480 is not running and/or not running at full capacity, when blower 450 and/or blower 460 are not running, etc.).

In some embodiments, the exhaust treatment system 500 can include an inlet valve 526 (for example, between the bypass valve 524 and the CAC 430) to control the inlet flow into the CAC 430 and subsequent components. As discussed herein, the first CAC 430 can be an ambient CAC 430 and can use ambient air to cool the exhaust gas. In some embodiments, it can take power 531 to run the CAC 430 and running the CAC 430, as well as WCAC 435, can produce condensate 532. Producing condensate 532 and reducing humidity (for example, reducing humidity in the exhaust gas) is beneficial for the exhaust treatment system 500 as the total amount of carbon dioxide adsorbed (and, in some instances, the rate of carbon dioxide adsorption) can be adversely affected by humidity. Reducing humidity in the gas before the CCS 480 and/or the carbon dioxide adsorbent in the CCS 480 can help improve the carbon dioxide adsorption capture efficiency of the CCS 480. Therefore, it is beneficial for the exhaust treatment system 500 and the CCS 480 to have a lower humidity entering the adsorbent bed (in the CCS 480), and thus it is beneficial to produce condensate 532.

In some embodiments, as discussed herein, various heat exchangers in the exhaust treatment system 500 can be water chillers. For example, WCAC 435, WCAC 465, and intercooler 452 may all use water to cool the exhaust gas. Therefore, exhaust treatment system 500 can include a chiller 553 that transmits coolant 554 to the water chillers (e.g., WCAC 435, WCAC 465, and intercooler 452). Chiller 553 can take power 531 to run, in some instances.

The blower 450 can be powered by a motor 547, in some embodiments. In some instances, a variable frequency drive (VFD) 546 can be used to drive/control the motor 547. In some instances, power 531 can be transmitted to the blower 450 from the motor 547 and, in some instances, the VFD 546. Similarly, blower 460 can be powered by motor 557 and, in some embodiments, motor 557 can be driven/controlled by VFD 556. In some embodiments, there can be a secondary safety relief after each blower (secondary safety relief 551 and secondary safety relief 561, respectively). Each secondary safety relief 551, 561 can be a backup pressure relief valve that can be opened to relieve pressure. The secondary safety relief valves 551, 561 can be a safety measure and can help prevent damage to the system 500.

In some embodiments, as discussed herein, coolant 554 can be transmitted to intercooler 452 from chiller 553. Intercooler 452 can produce condensate 532 from cooling the exhaust gas. In some embodiments, having blowers 450 and 460 in series (i.e., as serial blowers) can help facilitate condensation (for example, from components such as intercooler 452 producing condensate 532) between blowers 450 and 460 to increase the dew point of the exhaust gas. In some embodiments, intercooler 452 can operate at an elevated pressure in order to more easily condense unwanted water from the exhaust gas. The intercooler 452 may no longer need to cool to condense at a low temperature where exhaust gas condensate would rapidly freeze on the intercooler 452 face. This can reduce the cooling power required by the intercooler 452 between the blowers 450, 460 where excess unwanted water is condensed from the exhaust gas. In some instances, cooling between serial blowers 450, 460 (for example, by intercooler 452) can provide various advantages such as reducing input power (e.g., power 531) to the second blower 460 by cooling the inlet gas (i.e., exhaust gas) to blower 460 (thus effectively intercooling, but with having dual benefits of condensing and power reduction); reducing risk of liquid phase water into the carbon capture process downstream; and allowing for a temperature increase/re-heat of the exhaust gas via blower 460 compression, if desired. The exhaust gas can also be re-heated (i.e., increased in temperature) through CAH 455, for example, if the second blower 460 is not operated to a sufficiently high pressure ratio for the target downstream temperature (e.g., the target temperature for the CCS 480).

In some embodiments, as discussed herein, the first blower 450 can be controlled to maintain a target pressure (e.g., 0 kPa Gage pressure at the ATS 422 outlet) subject to blower limits for maximum gas temperatures, pressures, rpm, etc. The second blower 460 can be controlled to not only achieve the target pressure for carbon capture (at CCS 480), but also to provide a target pressure at the outlet of the first blower 450 (and/or at the inlet of the second blower 460) subject to blower limits. In some instances, the target pressure at the blower 450 outlet can be chosen to optimize the total power (e.g., power 531) consumed by various components of the system 500, such as blower 450, blower 460, chiller 553, WCAC 435, intercooler 452, etc. The power can be optimized (considering the components'efficiency characteristics) to support the targets for temperature, pressure, and humidity of the exhaust gas sent to the CCS 480. In some embodiments, the serial blowers 450 and 460 and the various components of the system 500 can synergize use of pressurized gas foundationally required for the CCS 480 to also enable condensing at a higher temperature, thus avoiding the need for a larger, heavier, more complex, more expensive chiller system to cool large gas flow rates at temperatures below the freezing point. Using a single blower (instead of blowers 450 and 460) may not have been feasible considering the desired carbon capture conditions-including a desired very high pressure ratio-as well as the higher risk of unwanted liquid state water being inputted into the carbon capture process (which could cause various issues for the CCS 480). Thus, system 500 includes a plurality of serial blowers 450, 460.

In some embodiments, exhaust gas can be recirculated 568 (at an outlet of WCAC 465) back to a recirculation valve 540 (at an inlet region of the blower 450). When recirculation valve 540 is open, the exhaust gas can be recirculated 568 and can be reinputted into the blower 450. Recirculating (568) the exhaust gas can be a primary safety/pressure relief for the system 500. Similar to secondary safety reliefs 551, 561, the recirculation/primary safety relief 568 can be a safety measure to release pressure and can help prevent damage to the system 500. By recirculating 568 exhaust gas back to the recirculation valve 540 and the blower 450 as the primary safety relief, pressure can be relieved while also avoiding release of the exhaust gas to the ambient outdoors 590 (as the gas is recirculated instead of simply being released into the atmosphere).

In some embodiments, as discussed herein, exhaust gas (for example, after being transmitted through WCAC 465) can be inputted into a CCS 480 in order to remove carbon dioxide from the exhaust gas. The CCS 480 can include, in some instances, storage (such as storage 34) to store the captured carbon dioxide and prevent it from being released into the ambient outdoors 590. The remaining exhaust gas (without the captured carbon dioxide) 582 (also referred to herein as cleaner exhaust gas and/or clean exhaust gas 582) can be released into the ambient outdoors 590.

In some embodiments, the exhaust treatment system 500 can include a back pressure regulator (BPR) 585, or electric control valve set, to achieve the target pressure in the CCS 480. A BPR 585 can control/regulate pressure upstream of the BPR 585 (i.e., pressure in the CCS 480, as the CCS 480 is upstream of the BPR 585). This can help increase the effectiveness of the CCS 480 due to the controlled/regulated pressure.

In some embodiments, the exhaust treatment system 500 can include a controller (not depicted) that controls the various components of the system 500.

As an example controls sequence for the exhaust treatment system 500, the blowers 450 and 460 may not yet be operating. Thus, in this example, the bypass valve 524 may be open and the exhaust gas from the locomotive 110 may be release to the ambient outdoors 590. This can occur, for example, when the engine is warming up, when carbon capture is not intended (for example, for certain modes), when diagnostics are occurring, when it is a safety open, etc. In some embodiments, the BPR 585 can be set to an intent initial position for target CCS 480 inlet pressure and flow rate. These can be pre-mapped positions, in some instances. In some embodiments, the inlet valve 526 can then be opened. The bypass valve 524 can be modulated to enable flow towards the blowers 450 and 460. In some embodiments, the system 500 can also simultaneously start ramping up the speeds of the blowers 450 and 460 (for example, through motors 547 and 557, respectively). This can be based on proportional-integral-derivative (PID) control to achieve the desired targets (e.g., target temperature, target pressure, target humidity, etc.), in some instances.

In some embodiments, the blower 450 priority may be to maintain the ATS 422 outlet at 0 kPa Gage pressure. In some embodiments, the blower 460 priorities may be to provide the target pressure for condensing, to operate to overcome downstream pressure drops, and to provide the target pressure wanted in the CCS 480. The BPR 585 may be modulated to provide a low pressure drop, yet enough to enable target pressure in the CCS 480. In some embodiments, CAC fans (for example, for CAC 430, WCAC 435, WCAC 465, etc.) may be driven to provide optimal process gas temperature reduction considering inlet process gas temperature and ambient temperature. For example, the CAC effectiveness, coolant flow rate pressure drops, whether CAC is more efficient than refrigeration cooling, etc. may be considered.

In some instances, if the target pressure and/or humidity for the CCS 480 is low while the target temperature is high, it is possible that the blowers 450, 460 may not be providing enough energy into the exhaust gas due to low compression at the outlet of the second blower 460. It is also possible that an energy efficient solution was implemented. In these instances, a CAH 455 can be used to raise the exhaust gas temperature to the higher target temperature. As the system 500 stabilizes for pressures and temperatures, blower 450, 460 speeds and CAC/cooler/chiller motor(s) for CAC 430, WCAC 435, chiller 553, intercooler 452, WCAC 465, etc. can be modulated to minimize power 531 consumption while maintaining 0 kPa Gage pressure at the ATS 422 outlet and meeting target pressure, temperature, and humidity at the CCS 480. In some instances, the CAC/cooler/chiller motor(s) can be a combination of refrigeration compressor(s), condenser fan(s), coolant pump(s), etc.

If and/or when the flow rate from the locomotive 110 changes, the energy/power 531 consumers (e.g., CAC 430, blower 450, blower 460, chiller 553, etc.) and the scheduling of the valve(s) 524, 526, 540, etc. can be modulated as a function of revised look up table settings as well as PID controls (in order to automatically compensate for variations based on tolerances, system volumes and lag, wear over time, etc.). In the example use cases(s) discussed herein, a controller may be transmitting instructions to execute the various operations discussed herein.

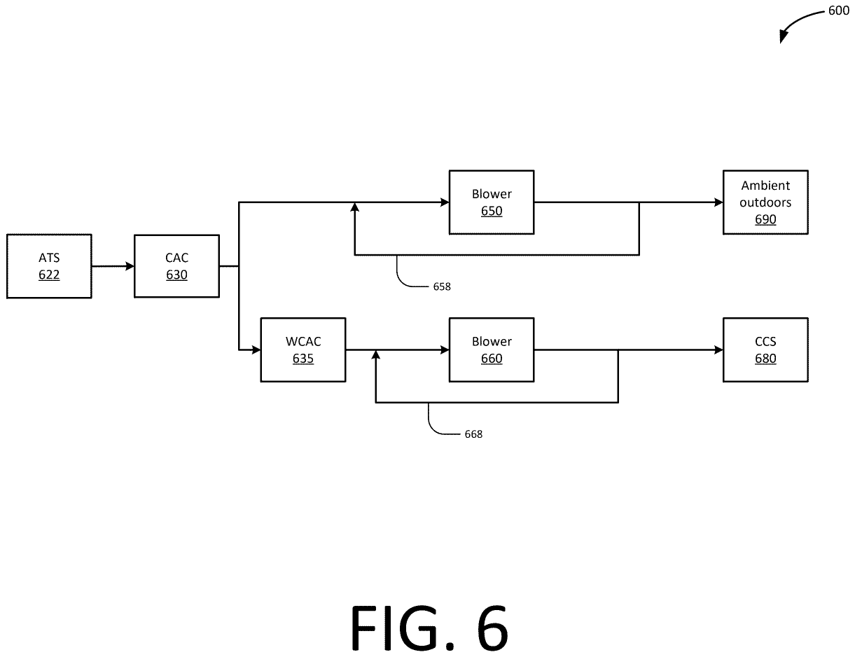

FIG. 6 illustrates an example exhaust treatment system 600 with parallel blowers, according to an embodiment. As discussed herein, an exhaust treatment system can include a plurality of blowers in series (as discussed in relation to FIGS. 3A, 4, and 5) and/or in parallel (as discussed in relation to FIGS. 3B, 6, and 7). When a system, such as exhaust treatment system 600 includes blowers 650, 660 in parallel, the exhaust gas can be transmitted through either blower 650 or blower 660. This can be beneficial for achieving target and/or necessary flow rates into the CCS 680 and preventing the blowers 650 and/or 660 from a surge and/or choke.

For example, when a locomotive 110 and capture car 120 are moving, the exhaust gas can be transmitted at various flow rates based on the speed and movement of the cars (110 and 120). These flow rates may not always be optimal for blower 650, 660 functionality and/or CCS 680 functionality. For instance, the CCS 680 may operate strategically to process only certain targeted flow rates (for example, as a function of engine emissions, ambient conditions, system design, efficiency, purity, and/or storage versus projected drive cycle) of exhaust gas. This can help maintain and/or improve the effectiveness of the CCS 680, as the CCS 680 may not be effective with certain flow rates (for example, too high of flow rates). In some instances, the blower 660 to the CCS 680 may be selected and/or operated for optimal efficiency for unique flow, pressure, and temperature ranges with a focus on pushing flow to the downstream CCS 680 and carbon capture process.

In some embodiments, exhaust gas can be transmitted from the ATS 622 to a charge air cooler (CAC) 630. In some embodiments, CAC 630 can be an ambient CAC 630 that uses ambient air to cool the exhaust gas. Utilizing ambient air (instead of, for example, using a water chiller/cooler) can reduce the amount of power necessary to execute the CAC 630 and cool the exhaust gas. In some embodiments, as depicted in FIG. 6, exhaust gas may only be transmitted to WCAC 635 (a water charge air cooler) if the exhaust gas is being transmitted to the blower 660 and the CCS 680. This way, significant cooling power can be saved as only a fraction of the total gas flow rate (i.e., the total exhaust gas transmitted from the locomotive 110 and/or through the ATS 622) is cooled by WCAC 635. WCAC 635 can, in some instances, use more power than CAC 630, as WCAC 635 may need to use chilled water whereas CAC 630 can cool using ambient air. Thus, transmitting only a fraction of the total gas flow rate through the WCAC 635 can reduce the amount of power used by the WCAC 635 to effectively cool the exhaust gas to a target temperature.

As discussed herein, exhaust treatment system 600 can include a plurality of blowers (blower 650 and 660) in parallel. In some embodiments, blower 650 can be a bypass blower 650 and blower 660 can be a feed blower 660. The bypass blower 650 can bypass the carbon capture system and can re-route exhaust gas to the ambient outdoors 690 (for example, at a variable flow rate). The exhaust gas being bypassed may be the fraction of process gas which is not ideal to flow into the CCS 680. For example, the carbon capture process and the CCS 680 may operate strategically to process only certain targeted flow rates as a function of engine emissions, ambient conditions, system design, efficiency, purity, and/or storage versus projected drive cycle. By processing only certain targeted flow rates, the CCS 680 can be more effective at removing carbon dioxide from the exhaust gas. For example, if the flow rate of the exhaust gas into the CCS 680 is too high, the CCS 680 may not effectively remove carbon dioxide from the exhaust gas. Therefore, exhaust treatment system 600 can utilize a bypass blower 650 that bypasses the CCS 680 and instead releases excess gas flow rates (i.e., excess exhaust gas) into the ambient outdoors 690.

The feed blower 660 can feed/flow/transmit exhaust gas to the CCS 680. In some embodiments, the feed blower 660 can be selected for optimal efficiency for unique and/or target flow, pressure, and temperature ranges with a focus on pushing/transmitting exhaust gas flow to the downstream CCS 680. In some embodiments, the feed blower 660 can be a non-positive displacement (non-PD) type blower, such as a multi-stage centrifugal, for higher efficiency (especially for a higher pressure ratio and higher flow rate blower). The bypass blower 650 can be selected to optimize efficiency for unique flow, pressure, and temperature ranges with a focus on assisting the feed blower 660 to pull process gas (i.e., exhaust gas) at higher total flow rates from engines and/or the ATS 622. In some embodiments, the bypass blower 650 can be a positive displacement (PD) type blower, such as roots, which can be modulated to provide improved resolution and tuning of inlet pressure. In some embodiments, the blower 650, 660 type(s) are selected to optimize input power consumption, size, weight, package space, and/or cost.

In some embodiments, including both a bypass blower 650 and a feed blower 660 in parallel with each other can save significant input compression power by pressurizing only a fraction of the total gas flow rate using the feed blower 660 (e.g., the fraction of the total exhaust gas desired for the CCS 680 and the carbon capture process). The exhaust gas flow transmitted to the feed blower 660 can be cooled efficiently by first using CAC 630 (an ambient heat exchanger) to cool the exhaust gas and then selectively using WCAC 635 (which, in some instances, can be a refrigeration heat exchanger) to condition the process gas for target humidity and/or temperature for the CCS 680. The exhaust gas flow transmitted to the bypass blower 650 may be cooled using only the CAC 630 in order to reduce blower 650 power and to remain below a maximum allowable inlet temperature for the blower 650.

In some embodiments, as discussed further herein, at lower total flow rates from the ATS 622 and/or the engine(s) of the locomotive, only the feed blower 660 may run and transmit exhaust gas into the CCS 680. For example, when the locomotive 110 speed is slower, the flow rate of exhaust gas (for example, from the locomotive) may be less and the CCS 680 may be able to effectively remove carbon dioxide from the entire exhaust gas flow at that slower flow rate. Thus, the system 600 can transmit the entire exhaust gas flow to the WCAC 635, the blower 660, and the CCS 680, in some instances. In some embodiments, at higher total flow rates from the ATS 622 and/or engine(s), the bypass blower 650 may be strategically ramped to transmit a portion of the exhaust gas flow to the bypass blower 650. For example, when the locomotive 110 speed is faster, the flow rate of exhaust gas may be more and the CCS 680 may not be able to effectively remove carbon dioxide from the entire exhaust gas flow at the faster flow rate. Thus, the system 600 can transmit some of the exhaust gas flow to the bypass blower 650, thus bypassing the CCS 680 and allowing the CCS 680 to remain effective in removing carbon dioxide from the portion of exhaust gas transmitted through the CCS 680. In some embodiments, a controller can control exhaust gas flow and whether exhaust gas is flowing to the blower 660 and/or blower 650 by, for instance, controlling the bypass inlet valve 745 (for example, opening and closing the bypass inlet valve 745). For example, the controller can be configured to open the bypass inlet valve 745 so that the exhaust gas flows from CAC 630 to blower 650. In some instances, when the bypass inlet valve 745 is closed, the exhaust gas can flow from the CAC 630 to WCAC 635 and then to blower 660.

In some embodiments, the blowers 650, 660 can have minimum and maximum flow rates in order for the blowers 650, 660 to be effective. For example, the blowers 650, 660 can choke if too much exhaust gas flow (i.e., too high of an exhaust gas flow rate) is transmitted through a blower 650, 660. By having blowers 650 and 660 in parallel, the exhaust gas flow rate from the ATS 622 can divided between the two blowers 650, 660, thus helping prevent too much exhaust gas from being transmitted to a single blower 650, 660 and causing a choke. Additionally, in some instances, the blowers 650, 660 can surge if too little exhaust gas flow is being transmitted through a blower 650, 660. A surge can be a reversal of flow. If blower 650 underwent a surge, the exhaust gas flow could be reversed back towards the CAC 630. If blower 660 underwent a surge, the exhaust gas flow could be reversed back towards the WCAC 635.

To help avoid blower 650, 660 surge, the exhaust gas can be recirculated 658, 668. For example, for bypass blower 650, instead of releasing the entire flow of exhaust gas to the ambient outdoors 690, some of the exhaust gas can be recirculated 658 back to the inlet of the blower 650. In another example, for feed blower 660, instead of transmitting the entire flow of exhaust gas from the blower 660 to the CCS 680, some of the exhaust gas can be recirculated 668 back to the inlet of the feed blower 660. In some embodiments, the exhaust gas could also and/or alternatively be recirculated 668 back to an inlet of the WCAC 635. Recirculation 658, 668 can occur when additional flow is needed to achieve a minimum blower flow rate (for blower 650, 660, respectively).

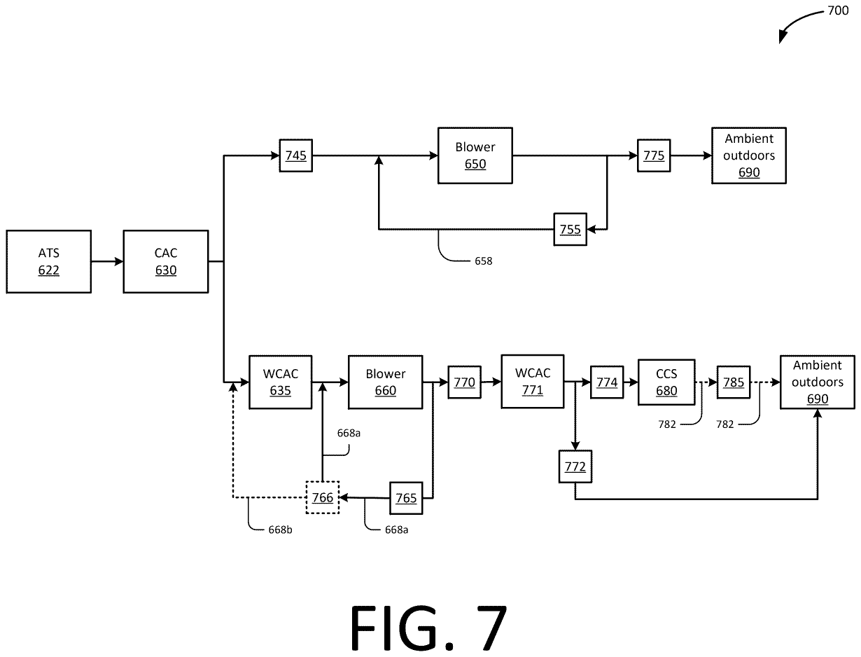

FIG. 7 illustrates an exhaust treatment system 700 with parallel blowers 650, 660, according to an embodiment. In some embodiments, exhaust treatment system 700 can be exhaust treatment system 600 with additional components. For instance, exhaust treatment system 700 can include a bypass inlet valve 745 to control the inlet flow into the bypass blower 650, a bypass recirculation valve 755 to control the recirculation exhaust gas flow (for example from the outlet of the bypass blower 650 to the inlet of the bypass blower 650), and/or a bypass outlet valve 775 to control the outlet flow out of the bypass blower 650. In some embodiments, the exhaust treatment system 700 can include a feed recirculation valve 765 to control the recirculation exhaust gas flow for the feed blower 660 (for example, from the outlet of the feed blower 660 to the inlet of the feed blower 660), a feed outlet valve 770 to control the outlet flow of the feed blower 660, an ambient bypass valve 772 to control flow from the feed blower 660 bypassing the CCS 680, an inlet CCS valve 774 to control an inlet flow into the CCS 680, and/or an outlet CCS valve 785 to control an outlet flow out of the CCS 680 and into the ambient outdoors 690. In some embodiments, a controller can be configured to control various exhaust gas flows by controlling (e.g., opening, closing, etc.) the various valves. In some embodiments, exhaust treatment system 700 can include less components (such as valves), more components (such as valves), etc. than the system 700 depicted in FIG. 7. For example, although not depicted, each blower 650, 660 can be powered by a VFD and motor (as depicted in FIG. 5). In some embodiments, the system 700 can include additional blowers, only a singular blower, etc.

The exhaust treatment system 700 can, in some instances, include a heat exchanger (such as WCAC 771) between the blower 660 and the CCS 680. This can help ensure that the exhaust gas has a target temperature, pressure, and/or humidity prior to entering the CCS 680. Although the WCAC 771 is depicted in FIG. 7 between the feed outlet valve 770 and the CCS valve 774, the WCAC 771 can be in any position between the blower 660 and the CCS 680.

In some embodiments, as discussed herein, the CCS 680 can reduce and/or remove carbon dioxide from the exhaust gas (in some instances, also storing the removed carbon dioxide). Thus, the outlet of the CCS 680 can be clean exhaust gas 782 (i.e., with removed and/or reduced carbon dioxide). This clean/cleaner exhaust gas 782 can be released into the ambient outdoors 690, in some instances (for example, when the outlet CCS valve 785 is opened). In some embodiments, there may be instances where it is not desirable to transmit exhaust gas through the CCS 680 (for example, in instances where the CCS 680 is not running and/or not running at full capacity, etc.). In these instances, the ambient bypass valve 772 can be opened and can transmit/round exhaust gas from the feed blower 660 to the ambient outdoors 690.

In some embodiments, it can be beneficial to recirculate 658, 668 blower 650 and/or 660 outlet exhaust gas (i.e., exhaust gas exiting the blower 650 and/or 660) back to the blower 650 and/or 660 inlet. This can help input at least a minimum amount (e.g., minimum flow rate) of exhaust gas into each blower 650, 660. The bypass recirculation valve 755 can be used to control the recirculation 658 and/or recirculation flow of exhaust gas for the bypass blower 650 and the feed recirculation valve 765 can be used to control the recirculation 668 and/or recirculation flow of exhaust gas for the feed blower 660. For example, a controller can be configured to control the bypass recirculation valve 755 and the feed recirculation valve 765, and can control the respective recirculation flows through the valves 755, 765.

However, as discussed herein, being transmitted through a blower can cause the exhaust gas to change temperature, pressure, humidity, etc. For example, exhaust gas can increase in temperature due to the blower 660. If the exhaust gas is recirculated back into the inlet of the blower 660 (as depicted in FIG. 6 and depicted as recirculation 668a in FIG. 7), the higher temperature exhaust gas from the outlet of the blower 660 will be recirculated 668a back into the blower 660, causing the exhaust gas to increase to an even higher temperature. Over time, the recirculated exhaust gas (from recirculation 668a) can increase to a high enough temperature to cause issues with the functioning of the blower 660 and/or other components of the system 700. Therefore, it can be desirable to cool the recirculated exhaust gas.

In some embodiments (not depicted), another heat exchanger could be added along the recirculation 668a path prior to the recirculated exhaust gas being reinputted into the blower 660. In some embodiments, as depicted in FIG. 7, the exhaust gas system 700 can include a second recirculation valve 766 to control the recirculation path and/or amount. Recirculation valve 765 can control whether any exhaust gas is being recirculated 668 and how much exhaust gas is being recirculated 668. Recirculation valve 766 can control the path of recirculation (i.e., whether the exhaust gas is being recirculated 668 to the inlet of the blower 660 (depicted by recirculation 668a) or whether the exhaust gas is being recirculated 668 to the inlet of the WCAC 635 (depicted by recirculation 668b)). Recirculating (668b) the exhaust gas to the inlet of WCAC 635 allows the exhaust gas to be cooled by WCAC 635 prior to being reinputted into the blower 660. This helps prevent the recirculated exhaust gas from getting to too high of a temperature and negatively affecting the system 700.

As discussed herein, there can be minimum and maximum flow rates for each blower 650, 660 to avoid surges and chokes, respectively. For example, if the locomotive 110 is positioned at an off notch, a low idle notch, a normal idle notch, and/or a dynamic braking notch, there may not be any (and/or there may be minimal) exhaust gas flow/flow rate from the locomotive 110 and/or the ATS 622. Therefore, there may not be a minimum flow rate to either bypass blower 650 or feed blower 660 and any inlet valves to either blower 650, 660 (such as bypass inlet valve 745 may be closed). In some instances (not depicted), exhaust treatment system 700 can include a bypass valve (similar to and/or the same as bypass valve 524) near an outlet of the ATS 622 in order to bypass the blowers 650, 660 and the CCS 680 and instead release the exhaust gas to the ambient outdoors 690. In these instances, the bypass valve can remain open when the locomotive 110 is off, low idle, normal idle, dynamic braking, etc. in order to release any minimal amount of exhaust gas to the atmosphere.

In an exemplary embodiment, the locomotive 110 can include at least notches 1-8 (for example, in addition to an off notch, a low idle notch, a normal idle notch, and/or a dynamic braking notch) that refer to numbered positions on the throttle control, with 1 being a low power and 8 being a high and/or full power. In some embodiments, when the locomotive 110 is at notch 1, the locomotive 110 may not produce a minimum flow rate of exhaust gas for blower 660. Therefore, in this exemplary instance, the exhaust gas from the locomotive can be transmitted to the ambient outdoors 690 (for example, either before or after being transmitted through the ATS 622). In these instances, the feed recirculation valve 765 can be closed, for example. The bypass inlet valve 745 can also be closed, in some instances.

In some embodiments, as the locomotive 110 picks up speed (for example, is in a notch 2 position), enough exhaust gas may be generated in order to hit a minimum flow rate of the feed blower 660. In some instances, even if the locomotive 110 is in a certain position/notch, the actual speed of the locomotive 110 and the flow rate of the exhaust gas could vary. For example, the locomotive 110 going uphill, downhill, and/or various other factors could affect the speed of the locomotive 110 even if the locomotive 110 is at the same notch. Therefore, in some instances, the locomotive can pick up enough speed and generate enough exhaust gas to achieve a minimum flow rate of the feed blower 660 even if the locomotive 110 remains at notch 1. For notches 2-5 of the locomotive 110, as an example, the locomotive 110 may generate enough exhaust gas flow to meet a minimum for the feed blower 660 without exceeding a maximum flow rate for the feed blower 660. Therefore, for these various speeds and corresponding notches of the locomotive 110, the exhaust treatment system 700 can transmit an entire flow of exhaust gas from the ATS 622, to the CAC 630, WCAC 635, blower 660, and CCS 680 (minus an amount of flow recirculated 668 back to the feed blower 660, in some embodiments).

However, between notches 5 and 6 (e.g., at notch 6 and/or instances of notch 5 where speed increases (for example, when the locomotive is going downhill)), the locomotive 110 may start generating too much exhaust flow for just the feed blower 660 (e.g., an exhaust flow above a maximum flow rate for the feed blower 660). Therefore, in these instances (for example, notches 6-8 of the locomotive 110), the bypass blower 650 can also be utilized so that excess exhaust gas flow can bypass the feed blower 660 and the CCS 680 to prevent the blower 660 from choking and/or the CCS 680 from not effectively removing carbon dioxide from the exhaust gas. The exhaust gas transmitted to the bypass blower 650 can be released to the ambient outdoors 690, in some instances.

In some embodiments, avoiding a surge can be more important for a non-PD blower such as the feed blower 660. Thus feed blower 660 can require a minimum inlet flow rate for surge avoidance. A PD blower, such as bypass blower 650, can still require a minimum inlet flow rate, even if surge avoidance is less of a concern. A minimum flow rate for a PD blower can help provide a higher inlet pressure at a lowest allowable revolutions per minute (rpm) (as PD blowers may have a required minimum rpm for sufficient oil circulation, as an example).

In some embodiments, the feed blower 660 can operate for the transition from/to N2 (i.e., notch 2) through N8 (i.e., notch 8). The bypass blower 650 can operate (for example, in addition to the feed blower 660) for the transition from/to N6 (i.e., notch 6) through N8. When the feed blower 660 is being operated alone (i.e., the bypass blower 650 is not being operated), the bypass inlet valve 745 can be closed to prevent/stop ambient leakage into the exhaust gas and to prevent reverse rotation of the bypass blower 650 motor (which could cause energy loss and other issues). In some instances, the bypass recirculation valve 755 can be open when the feed blower 660 is being operated alone in order to help reduce ramp up time for the future N5 (i.e., notch 5) to N6 transition. In some embodiments, when the feed blower 660 is being operated alone, the bypass outlet valve 775 may be closed to reduce ramp up time for the future N5 to N6 transition and to block ambient ingress (e.g., animals, nests, insects, rain, snow, etc.).

In some embodiments, there may be a ramp up between N5 and N6 in order for the bypass blower 650 to be operational and effective once the locomotive 110 reaches N6. This ramp up period can include having the bypass inlet valve 745 closed, having the bypass recirculation valve 755 open, and having the bypass outlet valve 775 closed (the valves may already be in these positions, in some instances). In some embodiments, the bypass blower 650 power may be quickly ramped up (for example, to full rpm) in order to recirculate gas and prevent an inlet of the bypass blower 650 from not having a minimum flow rate of gas. In some instances, as soon as the flow rate of the gas starts to increase, the bypass recirculation valve 755 may be open and modulated to flow to ambient in order to reduce pressure at the bypass blower 650 inlet. Then, in some instances, a controller can coordinate/modulate an open bypass inlet valve 745 and can modulate the bypass blower 650 rpm and/or gas flow rate. This can help ensure that both the bypass blower 650 and the feed blower 660 have a target flow rate (e.g., above a minimum flow rate and below a maximum flow rate for the specific blower-as each blower 650, 660 can have different requirements) and/or that the feed blower 660 can maintain the exhaust gas flow rate target through the feed blower 660. In some embodiments, the bypass valve 755 can be modulated to support the target flow rate of the feed blower 660 so that the CCS 680 can effectively remove carbon dioxide from the exhaust gas. In some embodiments, the various valves can be two-way valve(s), three-way valve(s), etc. For example, three-way valves can be positioned after blower(s) 650, 660 to function as tees after each blower outlet. This can help positively direct outlet flow (from the blowers 650, 660) to ensure that a recirculation flow rate and/or inlet flow rate (for the blowers 650, 660) is achieved.

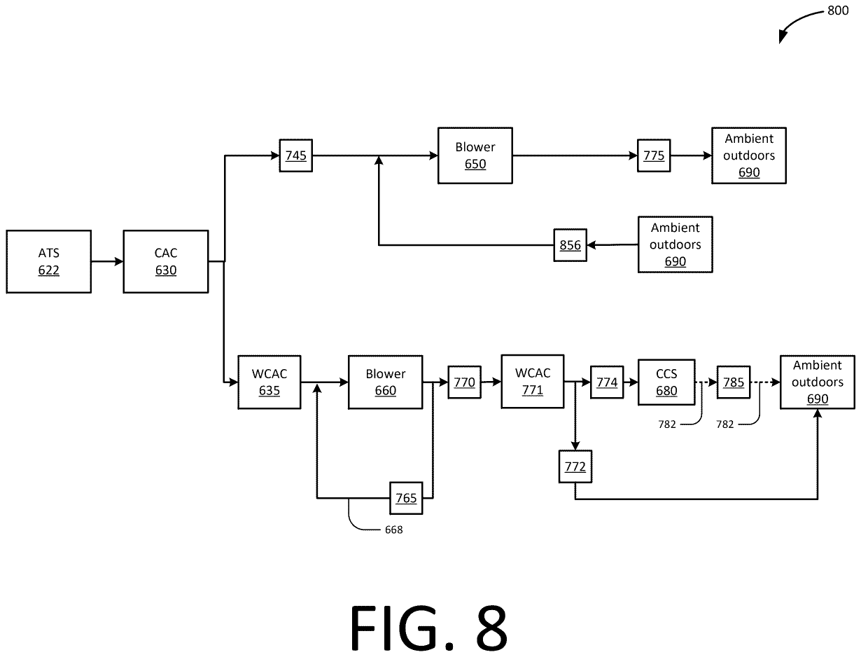

FIG. 8 depicts an exhaust treatment system 800, according to an embodiment. The components of exhaust treatment system 800 can be the same as and/or similar to exhaust treatment system 700, in some instances. As discussed herein in relation to recirculation 668, the blower 660 can increase the temperature of the exhaust gas, and when the exhaust gas is recirculated, the exhaust gas can keep increasing in temperature and can, over time, become too high of a temperature for the components of the system 800. Therefore, as depicted in FIG. 7, an exhaust treatment system can include a second recirculation valve 766 and a second recirculation path 668b, in some instances. Although not depicted in FIG. 8, system 800 can include second recirculation valve 766 and second recirculation path 668b, in some embodiments.

To help prevent recirculated exhaust gas (being recirculated at blower 650) from increasing to too high of a temperature, ambient air (from the ambient outdoors 690) can be inputted into the blower 650 instead of recirculating exhaust gas from the outlet of the blower 650. As discussed herein, there are instances where the exhaust gas may not have a high enough flow rate for blower 650 (i.e., does not meet a minimum flow rate of the blower 650). Therefore, in some instances, exhaust gas from the outlet of the blower 650 could be recirculated back to the inlet of the blower 650 to achieve at least a minimum flow rate for the blower 650. In some embodiments, instead of recirculating the exhaust gas, air from the ambient outdoors 690 could be added to the inlet to the blower 650 so that the inlet flow achieves the minimum flow rate. The air from the ambient outdoors 690 could go through a filter 856 prior to being inputted into the blower 650, in some instances. In some embodiments, although not depicted, there can be one or more valves between the ambient outdoors 690, the filter 856, and/or the inlet to the blower 650.

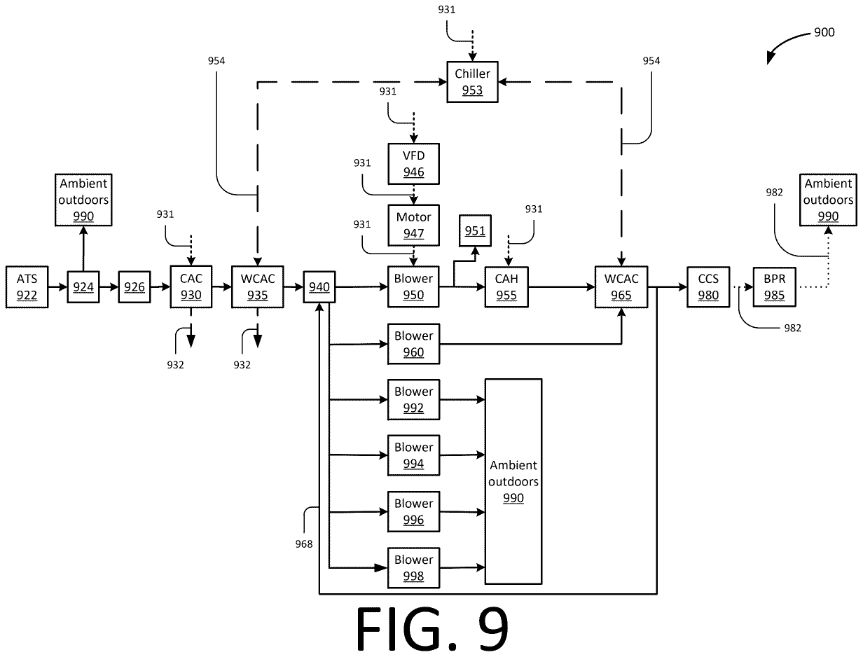

In some embodiments, an exhaust treatment system can include a combination of components in series and components in parallel. FIG. 9 illustrates one such example exhaust treatment system 900. The components of exhaust treatment system 900 can be the same as and/or similar to components of exhaust treatment system(s) 300, 400, 500, 600, 700, and/or 800. In some embodiments, as depicted in FIG. 9, exhaust gas can be transmitted from ATS 922 to bypass valve 924, where a controller controls the bypass valve 924 so that the exhaust gas either bypasses the CCS 980 and is released into the ambient outdoors 990, or continues to inlet valve 926, which controls the exhaust gas inlet flow into the CAC 930 and subsequent components. Components such as the CAC 930, WCAC 935, blower 950 (as well as blowers 960, 992, 994, 996, and 998), CAH 955, WCAC 965, etc. can be powered 931 (i.e., need power 931 to run), in some instances.

In some embodiments, exhaust gas can be transmitted from CAC 930 to WCAC 935. System 900 can include a chiller 953 that transmits coolant 954 to the water chillers (e.g., WCAC 935, WCAC 965, etc.). System 900 can include a recirculation valve 940 that controls the recirculation flow 968 and the flow of exhaust gas into the blower(s) 950, 960, 992, 994, 996, 998, etc. Exhaust gas that is transmitted through blower 950 can be transmitted to secondary safety relief 951 that can be a backup pressure relief valve that can be opened to relieve pressure. When secondary safety relief 951 is closed, the exhaust gas can be transmitted from blower 950 to CAH 955 from CAH 955 to WCAC 965. Exhaust gas at the outlet of WCAC 965 can be transmitted to the CCS 980 and/or can be recirculated 968 back to the inlet valve 940 and to the inlet of one or more of the blowers 950, 960, 992, 994, 996, 998, etc. Exhaust gas transmitted to blower 960 can flow through blower 960 and be transmitted to WCAC 965. Once exhaust gas has been processed by the CCS 980, the carbon dioxide has been removed and cleaner gas 982 can be outputted from the CCS 980, be transmitted to the BPR 985 and to the ambient outdoors 990.

In some embodiments, although the exhaust treatment system(s) herein have been discussed as having two blowers, the system(s) can include any number of blowers. For example, system(s) 300, 400, 500, 600, 700, 800, and/or 900 can have a single large blower, in some embodiments. As another example, system(s) 300, 400, 500, 600, 700, 800, and/or 900 can have a plurality of blowers. System 900 depicts an example exhaust treatment system with six blowers (950, 960, 992, 994, 996, 998), however the exhaust treatment system can include any number of blowers. In example system 900, the first two blowers—blowers 950 and 960—can transmit exhaust flow to the CCS 980. Blowers 992, 994, 996, and 998 can transmit exhaust to the ambient outdoors 990. In some embodiments, each blower 950, 960, 992, 994, 996, 998 can be powered by its own motor (and corresponding VFD, in some instances). In some instances, a single motor can power a plurality of blowers 950, 960, 992, 994, 996, and/or 998. For example, blowers 950 and 960 could be powered by the same motor and could have a belt/chain system between them. Blowers 992, 994, 996, and 998 could be powered by a singular motor and could have a corresponding belt system between them. In some embodiments, in instances where not all blowers 950, 960, 992, 994, 996, 998 are operating, the nonoperating motors could be declutched. This can help increase the efficiency of the system 900. In some embodiments (not depicted), the system 900 (and/or systems 300, 400, 500, 600, 700, and/or 800) could include one or more superchargers.

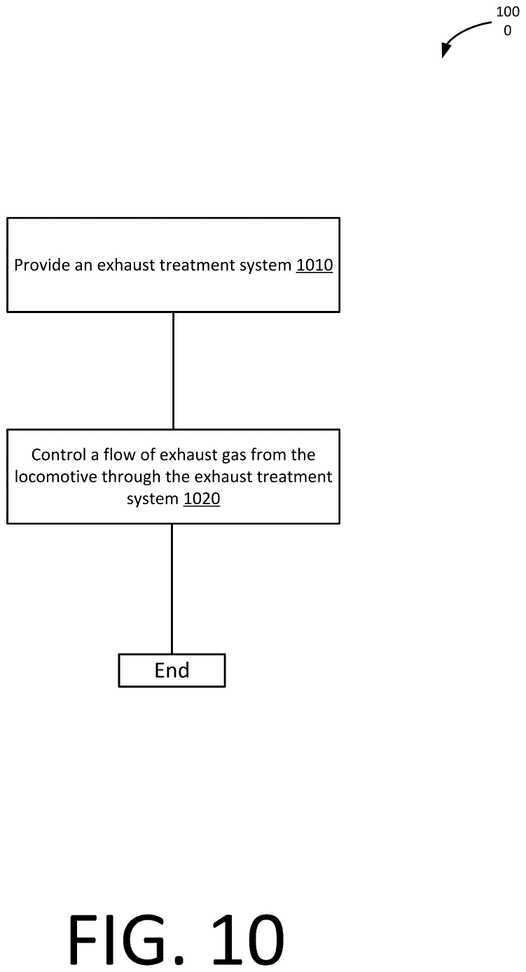

FIG. 10 illustrates a method 1000 of transmitting locomotive engine exhaust gas (for example, through an exhaust treatment system), according to an embodiment. In some embodiments, the method 1000 can include operation 1010 of providing an exhaust treatment system. The exhaust treatment system can be a system such as exhaust treatment system 300, exhaust treatment system 400, exhaust treatment system 500, exhaust treatment system 600, and/or exhaust treatment system 700. The method 1000 can also include controlling a flow of exhaust gas from a locomotive (such as locomotive 110) through an exhaust treatment system, which as discussed herein can be on a capture car 120 in some instances. In some embodiments, a controller can be utilized to control the various components of the exhaust treatment system (e.g., 300, 400, 500, 600, and/or 700).

In some embodiments, for example when the first blower (e.g., blower 350 and/or 450) and the second blower (e.g., blower 360 and/or 460) are in series, controlling the flow of exhaust gas (i.e., operation 1020) can include transmitting the exhaust gas through the first heat exchanger to cool the exhaust gas. As discussed herein, a first heat exchanger (such as heat exchanger 330 and/or CAC 430) can use ambient air to cool the exhaust feed to a more manageable temperature for the components of the exhaust treatment system. In some embodiments, operation 1020 can also include transmitting the exhaust gas through a second heat exchanger to condition the exhaust gas for target humidity and target temperature for the carbon capture system. In some embodiments, the second heat exchanger can be a charge air cooler such as heat exchanger 335 (FIG. 3A) and/or WCAC 435 (FIGS. 4 and 5).

Operation 1020 can include transmitting the exhaust gas through the first blower (for example, from the second heat exchanger). As discussed herein, the first blower can be controlled to maintain 0 kPa Gage pressure at the ATS outlet, in some instances. The exhaust gas can also be transmitted through a second blower to condition the exhaust gas for target pressure for the carbon capture system (CCS). Conditioning the exhaust gas for target temperature, humidity, and/or pressure for the CCS can help improve the effectiveness of the CCS at removing carbon dioxide from the exhaust gas, in some instances. In some embodiments, at least a portion of the exhaust gas can be transmitted to (and processed by) the CCS. In some instances, the exhaust gas may go through additional components such as WCAC 465 prior to entering the CCS. In some embodiments, a portion of exhaust gas can be recirculated 568 to an inlet of the first blower.

In some embodiments, for example when the first blower (e.g., blower 350 and/or 650) and the second blower (e.g., blower 360 and/or 660) are in parallel, controlling the flow of exhaust gas (i.e., operation 1020) can include determining where (e.g., which blower) to transmit the exhaust gas (and, in some instances, how much of the exhaust gas flow to transmit). As discussed herein, when the blowers are in parallel, the exhaust gas can be transmitted to either the first blower (e.g., the bypass blower) or the second blower (e.g., the feed blower). The feed blower can transmit the exhaust gas to the CCS and/or recirculate some of the exhaust gas back to an inlet of the feed blower to maintain a minimum flow rate of exhaust gas into the second blower/feed blower. The bypass blower can bypass the CCS and can instead transmit the exhaust gas to the ambient outdoors and/or recirculate some of the exhaust gas back to an inlet of the bypass blower to maintain a minimum flow rate of exhaust gas into the first blower/bypass blower. In some embodiments, where to transmit (and how much to transmit) the exhaust gas can be dependent on an exhaust gas flow rate from the locomotive engine and/or the ATS. The exhaust gas flow rate can change based on a throttle position and/or a speed of the locomotive, in some embodiments.

Therefore, in some instances, operation 1020 can include determining a throttle position of the locomotive (e.g., off, low idle, normal idle, dynamic braking, 1, 2, 3, 4, 5, 6, 7, 8, etc.); based on the throttle position, determining an amount of the exhaust gas to transmit to the second blower (e.g., the feed blower); and determining whether any of the exhaust gas should bypass the second blower and be transmitted to the first blower. In some embodiments, as discussed herein, when the locomotive has a throttle position less than notch 2, both the first blower and the second blower can be off and any exhaust gas being transmitted can be released into the ambient outdoors. At such low speeds/notches, the locomotive may not produce enough exhaust gas flow for the blowers to meet a minimum flow rate in order for the blowers and/or the CCS to effectively operate.

In some embodiments, for notches 2-5 of the locomotive, the locomotive may generate enough exhaust gas flow to meet a minimum for the feed blower/second blower without exceeding a maximum flow rate for the feed blower. Therefore, for these various speeds and corresponding notches of the locomotive, the exhaust treatment system can transmit an entire flow of exhaust gas from the ATS, to the CAC, WCAC, feed blower/second blower, and CCS (minus any amount of flow recirculated back to the feed blower, in some embodiments). In some embodiments, between notches 5 and 6, the locomotive may start generating too much exhaust flow for just the feed blower/second blower (e.g., an exhaust flow above a maximum flow rate for the feed blower). Therefore, in these instances (for example, notches 6-8 of the locomotive), the bypass blower/first blower can also be utilized so that excess exhaust gas flow can bypass the feed blower and the CCS to prevent the feed blower from choking and/or the CCS from not effectively removing carbon dioxide from the exhaust gas. The exhaust gas transmitted to the bypass blower can be released to the ambient outdoors, in some instances.

In some embodiments, the controller can direct flow of the exhaust gas by opening and closing various valves of the exhaust treatment system (for example, valves 524, 526, 540, 551, 561, 745, 755, 765, 772, 775, 785, etc.). In some embodiments, method 1000 and/or operation 1020 of controlling the flow of exhaust gas from the locomotive through the exhaust treatment system can include additional and/or alternative operations as discussed herein.

Advantages of embodiments disclosed herein include removing various harmful chemicals from locomotive exhaust (e.g., using an aftertreatment system and/or carbon capture system), improving the effectiveness of the carbon capture system by achieving/controlling target pressure, temperature, and humidity ranges for the exhaust gas, preventing surges and/or chokes of various blowers in an exhaust treatment system by controlling flow rates of exhaust gas through the various blowers, etc.

To facilitate an understanding of the subject matter described herein, many aspects are described in terms of sequences of actions. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the application. The use of any and all examples, or exemplary language (e.g., “such as”) provided herein, is intended merely to better illustrate the subject matter and does not pose a limitation on the scope of the subject matter. The use of the term “based on” and other like phrases indicating a condition for bringing about a result, both in any claims and in the written description, is not intended to foreclose any other conditions that bring about that result. No language in the specification should be construed as indicating any non-claimed element as essential to the practice any claimed inventions.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of this disclosure. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Thus, embodiments of a railcar system and an exhaust treatment system with a carbon capture system and a plurality of blowers are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. An exhaust treatment system comprising:
a first heat exchanger configured to cool exhaust gas transmitted from an aftertreatment system;
a second heat exchanger configured to cool at least a first portion of exhaust gas transmitted from the first heat exchanger;
a first blower;
a second blower, wherein the second blower is configured to transmit the exhaust gas to a carbon capture system; and
a controller configured to control operation of the first blower and the second blower.

2. The exhaust treatment system of claim 1, wherein the first blower and the second blower are in series with each other.

3. The exhaust treatment system of claim 2, wherein the first blower and the second blower are separated by at least an intercooler, wherein the intercooler is configured to condition one or more of temperature, pressure, and humidity of the exhaust gas for the carbon capture system.

4. The exhaust treatment system of claim 3, further comprising a charge air heater downstream from the intercooler and upstream from the second blower.

5. The exhaust treatment system of claim 2, further comprising:
a third heat exchanger between the second blower and the carbon capture system; and
a recirculation valve at an inlet region of the first blower configured to, when open, recirculate at least a portion of the exhaust gas from an outlet of the third heat exchanger back to the first blower.

6. The exhaust treatment system of claim 2, wherein:
the controller is configured to control the first blower to maintain 0 kPa Gage pressure at an outlet of the aftertreatment system; and
the controller is configured to control the second blower to achieve a target pressure for the carbon capture system.

7. The exhaust treatment system of claim 1, wherein the first blower and the second blower are in parallel with each other.

8. The exhaust treatment system of claim 7, further comprising a bypass inlet valve, wherein:
the controller is configured to control the bypass inlet valve such that at least the first portion of exhaust gas is transmitted from the second heat exchanger to the second blower; and
when the controller is configured to open the bypass inlet valve, the exhaust gas flows from the first heat exchanger to the first blower.

9. The exhaust treatment system of claim 8, wherein the controller is configured to control the bypass inlet valve based on a total flow rate of exhaust gas from a locomotive.

10. The exhaust treatment system of claim 7, wherein:
the first blower comprises a bypass blower configured to bypass the carbon capture system; and
the second blower comprises a feed blower configured to flow the exhaust gas to the carbon capture system.

11. The exhaust treatment system of claim 7, further comprising:
a bypass recirculation valve, wherein the controller is configured to control, using the bypass recirculation valve, a first recirculation exhaust gas flow from a first outlet of the first blower to a first inlet of the first blower; and
a feed recirculation valve, wherein the controller is configured to control, using the feed recirculation valve, a second recirculation exhaust gas flow from a second outlet of the second blower to a second inlet of the second blower.

12. The exhaust treatment system of claim 1, wherein:
the first heat exchanger comprises an ambient charge air cooler; and
the second heat exchanger comprises a water charge air cooler.

13. A railcar system comprising:
an exhaust treatment system comprising:
an aftertreatment system;
a first heat exchanger;
a second heat exchanger;
a first blower;
a second blower;
a controller configured to control operation of the first blower and the second blower; and
a carbon capture system configured to remove carbon dioxide from exhaust gas, wherein the second blower is configured to transmit the exhaust gas to the carbon capture system.

14. The system of claim 13, further comprising:
an intercooler downstream from the first blower; and
a charge air heater downstream from the intercooler, wherein the second blower is downstream from the charge air heater.

15. The system of claim 14, further comprising:
a third heat exchanger downstream from the second blower, wherein the carbon capture system is downstream from the third heat exchanger.

16. The system of claim 13, further comprising:
a bypass valve, wherein:
when the controller is configured to open the bypass valve, the exhaust gas is transmitted to the first blower; and
when the controller is configured to close the bypass valve, the exhaust gas is transmitted to the second blower.

17. The system of claim 13, wherein the exhaust treatment system is on a capture car mechanically coupled to a locomotive.

18. A method of transmitting locomotive engine exhaust gas, the method comprising:
providing an exhaust treatment system, the exhaust treatment system comprising:
an aftertreatment system;
a first heat exchanger configured to cool exhaust gas being transmitted from the aftertreatment system;
a second heat exchanger configured to cool at least a first portion of exhaust gas being transmitted from the first heat exchanger;
a first blower;
a second blower; and
a carbon capture system configured to remove carbon dioxide from the exhaust gas from a locomotive, wherein the second blower is configured to transmit the exhaust gas to the carbon capture system; and
controlling a flow of exhaust gas from the locomotive through the exhaust treatment system.

19. The method of claim 18, wherein controlling the flow of exhaust gas from the locomotive through the exhaust treatment system comprises:
transmitting the exhaust gas through the first heat exchanger to cool the exhaust gas;
transmitting the exhaust gas through the second heat exchanger to condition the exhaust gas for target humidity and target temperature for the carbon capture system;
transmitting the exhaust gas through the first blower;
transmitting the exhaust gas through the second blower, wherein the second blower conditions the exhaust gas for target pressure for the carbon capture system; and
transmitting at least a portion of the exhaust gas to the carbon capture system.

20. The method of claim 18, wherein the first blower and the second blower are in parallel, and wherein controlling the flow of exhaust gas from the locomotive through the exhaust treatment system comprises:
determining a throttle position of the locomotive;
based on the throttle position, determining an amount of the exhaust gas to transmit to the second blower; and
determining whether any of the exhaust gas should bypass the second blower and be transmitted to the first blower.
